(19) United States
(12) Patent Application Publication
(10) Pub. No.: US 2018/0293037 A1
(43) Pub. Date: Oct. 11, 2018

(54) Electronic Calendar Assembly

(71) Applicant: Eduardo Rodriguez, Norwalk, CA (US)

(72) Inventor: Eduardo Rodriguez, Norwalk, CA (US)

(21) Appl. No.: 15/481,184

(22) Filed: Apr. 6, 2017

(51) Int. Cl. G06F 3/14; H04W 4/02; G01S 19/13

(52) U.S. Cl. CPC G06F 3/14; G09G 3/36; G01S 19/13; H04W 4/025

(57) ABSTRACT

An electronic calendar assembly includes a panel that may be positioned on a support surface. A communication unit is coupled to the panel and the communication unit is configured to be in electrical communication with an extrinsic communication network. In this way the communication network receives a weather forecast for a selected location. A display is coupled to the panel and the display displays a monthly calendar. The display is in electrical communication with the communication unit such that the display receives the weather forecast. Moreover, the display displays the weather forecast for each day of the month.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to calendar devices and more particularly pertains to a new calendar device for combining a monthly calendar and a daily weather forecast.

### BRIEF SUMMARY OF THE INVENTION

An embodiment of the disclosure meets the needs presented above by generally comprising a panel that may be positioned on a support surface. A communication unit is coupled to the panel and the communication unit is configured to be in electrical communication with an extrinsic communication network. In this way the communication network receives a weather forecast for a selected location. A display is coupled to the panel and the display displays a monthly calendar. The display is in electrical communication with the communication unit such that the display receives the weather forecast. Moreover, the display displays the weather forecast for each day of the month.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an electronic calendar assembly according to an embodiment of the disclosure.

FIG. 2 is a back phantom view of an embodiment of the disclosure.

FIG. 3 is a right side view of an embodiment of the disclosure.

FIG. 4 is a front view of an embodiment of the disclosure.

FIG. 5 is a perspective view of an alternative embodiment of the disclosure.

FIG. 6 is a schematic view of an embodiment of the disclosure.

### DETAILED DESCRIPTION OF THE INVENTION

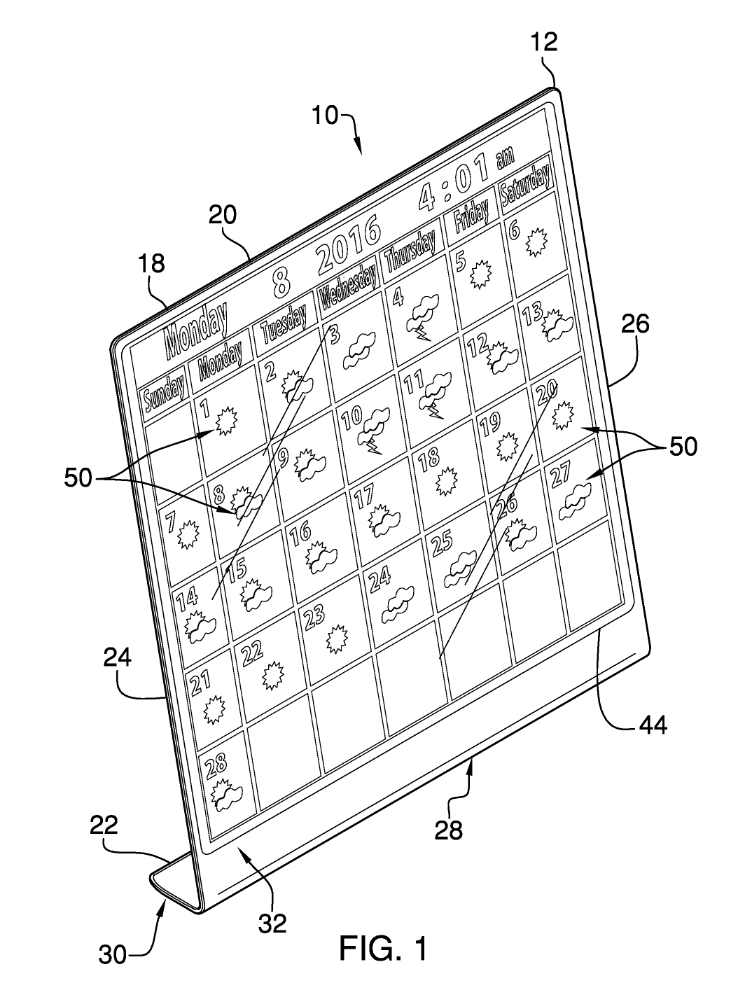

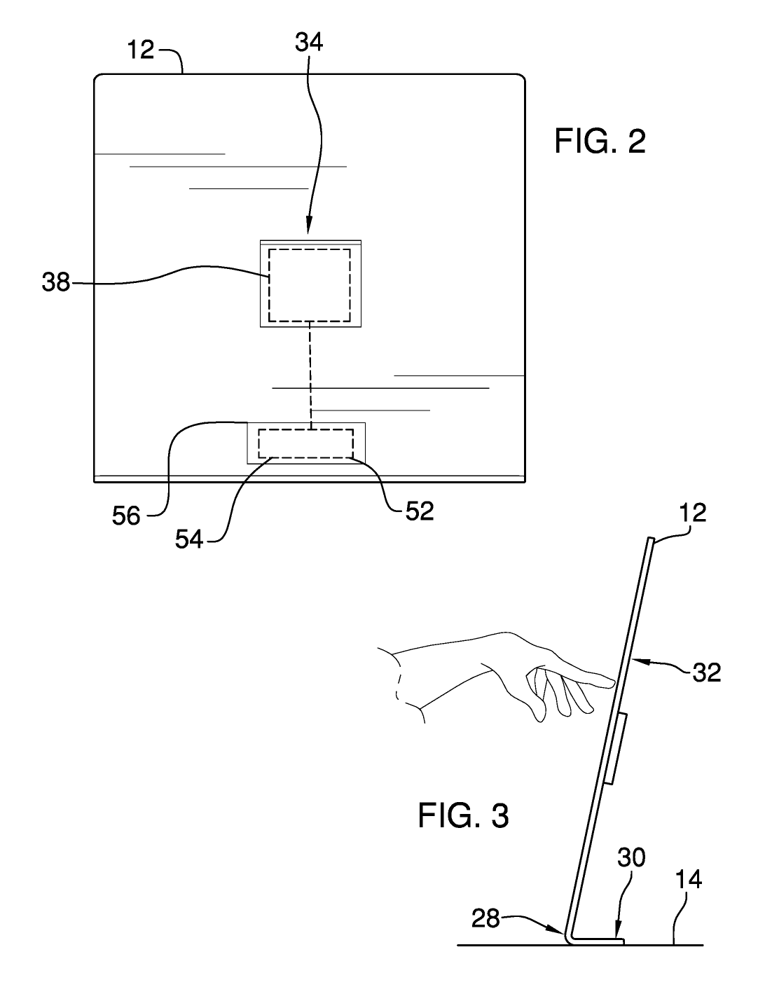

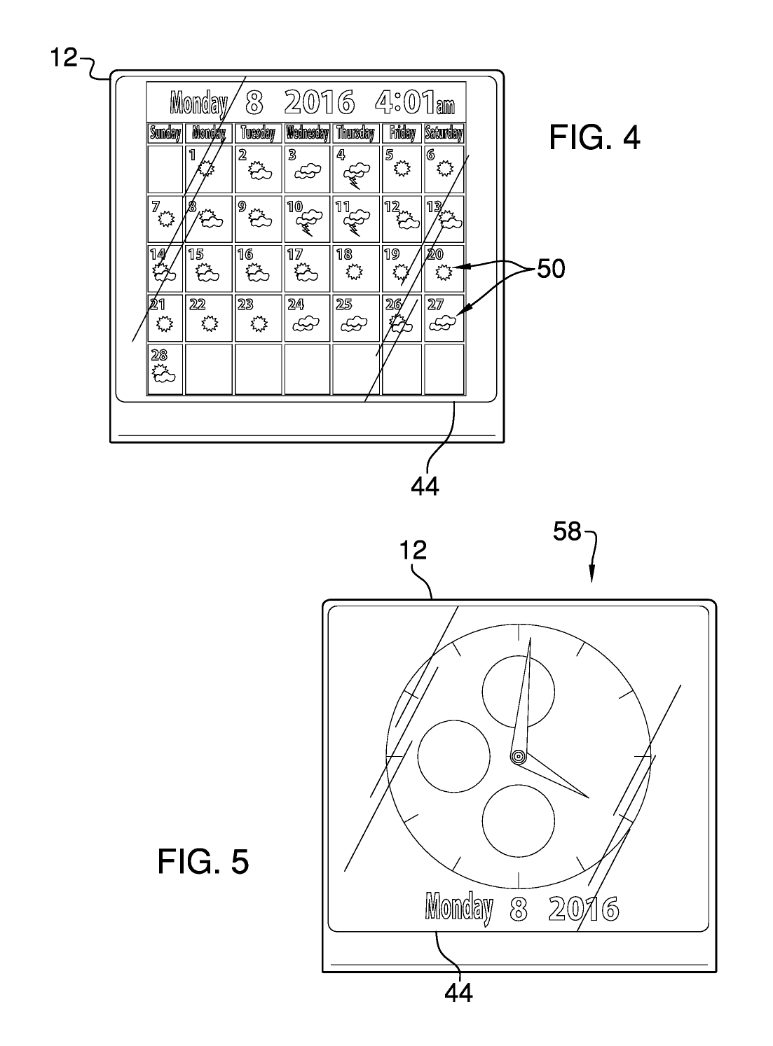

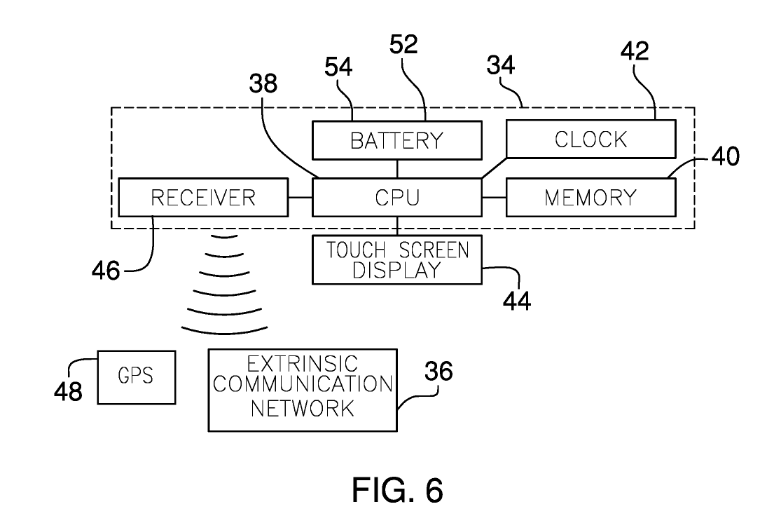

With reference now to the drawings, and in particular to FIGS. 1 through 6 thereof, a new calendar device embodying the principles and concepts of an embodiment of the disclosure and generally designated by the reference numeral 10 will be described.

As best illustrated in FIGS. 1 through 6, the electronic calendar assembly 10 generally comprises a panel 12 that may be positioned on a support surface 14. The panel 12 has a first surface 16 and a peripheral edge 18 and the peripheral edge 18 has a top side 20, a bottom side 22, a first lateral side 24 and a second lateral side 26. The panel 12 has a bend 28 extending between the first lateral side 24 and the second lateral side 26 to define a first portion 30 of the panel 12 forming an angle with respect to a second portion 32 of the panel 12. Moreover, the bend 28 is positioned closer to the bottom side 22 than the top side 20. The first portion 30 rests on the support surface 14 thereby facilitating the second portion 32 to be substantially vertically oriented. The support surface 14 may be a table top, a desk or other horizontal support surface 14.

A communication unit 34 is provided and the communication unit 34 is coupled to the panel 12. The communication unit 34 is in electrical communication with an extrinsic communication network 36. In this way the communication unit 34 receives a weather forecast for a selected location. The communication unit 34 comprises a processor 38 that is coupled to the panel 12 and the processor 38 may be an electronic processor 38 or the like.

An electronic memory 40 is coupled to the panel 12 and the electronic memory 40 is electrically coupled to the processor 38. The electronic memory 40 stores data pertaining to a monthly calendar. Moreover, the electronic memory 40 may be RAM memory or other electronic memory 40 capable of storing digital information. An electronic clock 42 is coupled to the panel 12 and the electronic clock 42 is electrically coupled to the processor 38.

A display 44 is coupled to the panel 12 such that the display 44 is visible to an observer. The display 44 displays a monthly calendar and the display 44 is in electrical communication with the communication unit 34 such that the display 44 receives the weather forecast. Thus, the display 44 displays the weather forecast for each day of the month. The display 44 is electrically coupled to the processor 38 and the monthly calendar is displayed in a grid having days of the week being arranged from left to right. The display 44 displays a time of day from the electronic clock 42 and the time of day may be displayed above the monthly calendar. The display 44 may comprise a touch screen LCD or the like.

A receiver 46 is provided and the receiver 46 is coupled to the panel 12. The receiver 46 is electrically coupled to the processor 38 and the receiver 46 is in wireless electrical communication with a global positioning system (gps) 48. In this way the receiver 46 receives a physical location of the panel 12 from the gps 48. The receiver 46 may be a radio frequency receiver 46 or the like.

The receiver 46 is in wireless electrical communication with the extrinsic communication network 36. In this way the receiver 46 receives a weather forecast corresponding to the physical location of the panel 12. The extrinsic communication network 36 may be the internet or the like and the receiver 46 additionally receives the time of day corresponding to the physical location of the panel 12. In this way the time received from the electronic clock 42 is correct with respect to time zones and geography. The receiver 46 may employ a WPAN signal to communicate with internet routers or other hardware associated with internet connectivity.

The display 44 displays indicia 50 relating to the weather forecast corresponding to each day of the month. Additionally, the indicia 50 corresponding to each day of the month is displayed on each day of a traditional monthly calendar. In this way the display 44 facilitates an observer to identify the weather forecast of a selected day of the month. The indicia 50 may comprise an image of the sun to indicate a forecast of clear and sunny skies. The indicia 50 may further comprise an image of the sun partially obstructed by a cloud indicating a forecast of partly cloudy skies. Additionally, the indicia 50 may comprise an image of a plurality of clouds indicating a forecast of cloudy skies. The indicia 50 may finally comprise an image of clouds and a lightning bolt indicating a forecast of thunderstorms or other forms of precipitation.

A power supply 52 is provided and the power supply 52 is coupled to the panel 12. Additionally, the power supply 52 is electrically coupled to the processor 38. The power supply 52 comprises at least one battery 54. A battery cover 56 is removably coupled to the panel 12 and the battery 54 is positioned beneath the battery cover 56. In an alternative embodiment 58 as shown in FIG. 5, the display 44 may display an analog clock and the current date.

In use, the panel 12 is positioned on the support surface 14 and the receiver 46 receives the physical location of the panel 12 and the weather forecast. The display 44 displays the monthly calendar and the time of day. Additionally, the display 44 displays the indicia 50 corresponding to the weather forecast for each day of the month. In this way the weather forecast for any day of the month is available to be observed. Additionally, the weather forecast for each day of the month is continuously updated the by receiver 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic calendar assembly being configured to display weather forecasts for each day of a month, said assembly comprising:
a panel being configured to be positioned on a support surface;
a communication unit being coupled to said panel, said communication unit being configured to be in electrical communication with an extrinsic communication network thereby facilitating said communication network to receive a weather forecast for a selected location; and
a display being coupled to said panel wherein said display is configured to be visible, said display displaying a monthly calendar, said display being in electrical communication with said communication unit such that said display receives the weather forecast, said display displaying the weather forecast for each day of the month.

2. The assembly according to claim 1, wherein said panel has a first surface and a peripheral edge, said peripheral edge having a top side, a bottom side, a first lateral side and a second lateral side, said panel having a bend extending between said first lateral side and said second lateral side to define a first portion of said panel forming an angle with respect to a second portion of said panel, said bend being positioned closer to said bottom side than said top side, said first portion being configured to rest on the support surface thereby facilitating said second portion to be substantially vertically oriented.

3. The assembly according to claim 1, wherein said communication unit comprises a processor being coupled to said panel.

4. The assembly according to claim 3, further comprising an electronic memory being coupled to said panel, said electronic memory being electrically coupled to said processor, said electronic memory storing data pertaining to a monthly calendar.

5. The assembly according to claim 3, further comprising an electronic clock being coupled to said panel, said electronic clock being electrically coupled to said processor.

6. The assembly according to claim 5, wherein said display is electrically coupled to said processor such that said display displays said monthly calendar, said monthly calendar being displayed in a grid having days of the week being arranged from left to right, said display displaying a time of day from said electronic clock.

7. The assembly according to claim 3, further comprising a receiver being coupled to said panel, said receiver being electrically coupled to said processor, said receiver being configured to be in electrical communication with a global positioning system (gps) thereby facilitating said receiver to identify a physical location of said panel, said receiver being configured to be in electrical communication with an extrinsic communication network thereby facilitating said receiver to receive a weather forecast corresponding to the physical location of said panel, said display displaying indicia relating to the weather forecast corresponding to each day of the month wherein said display is configured to facilitate an observer to identify the weather forecast for each day of the month.

8. The assembly according to claim 3, further comprising a power supply being coupled to said panel, said power supply being electrically coupled to said processor, said power supply comprising at least one battery.

9. An electronic calendar assembly being configured to display weather forecasts for each day of a month, said assembly comprising:
a panel being configured to be positioned on a support surface, said panel having a first surface and a peripheral edge, said peripheral edge having a top side, a bottom side, a first lateral side and a second lateral side, said panel having a bend extending between said first lateral side and said second lateral side to define a first portion of said panel forming an angle with respect to a second portion of said panel, said bend being positioned closer to said bottom side than said top side, said first portion being configured to rest on the support surface thereby facilitating said second portion to be substantially vertically oriented;
a communication unit being coupled to said panel, said communication unit being configured to be in electrical communication with an extrinsic communication network thereby facilitating said communication network to receive a weather forecast for a selected location, said communication unit comprising:
a processor being coupled to said panel;
an electronic memory being coupled to said panel, said electronic memory being electrically coupled to said processor, said electronic memory storing data pertaining to a monthly calendar;
an electronic clock being coupled to said panel, said electronic clock being electrically coupled to said processor;
a display being coupled to said panel wherein said display is configured to be visible, said display displaying a monthly calendar, said display being in electrical communication with said communication unit such that said display receives the weather forecast, said display displaying the weather forecast for each day of the month, said display being electrically coupled to said processor, said monthly calendar being displayed in a grid having days of the week being arranged from left to right, said display displaying a time of day from said electronic clock;
a receiver being coupled to said panel, said receiver being electrically coupled to said processor, said receiver being configured to be in electrical communication with a global positioning system (gps) thereby facilitating said receiver to identify a physical location of said panel, said receiver being configured to be in electrical communication with an extrinsic communication network thereby facilitating said receiver to receive a weather forecast corresponding to the physical location of said panel, said display displaying indicia relating to the weather forecast corresponding to each day of the month wherein said display is configured to facilitate an observer to identify the weather forecast for each day of the month; and
a power supply being coupled to said panel, said power supply being electrically coupled to said processor, said power supply comprising at least one battery.
